(19) United States
(12) Patent Application Publication
(10) Pub. No.: US 2022/0123387 A1
(43) Pub. Date: Apr. 21, 2022

(54) BATTERY MODULE

(71) Applicant: JIANGSU CONTEMPORARY AMPEREX TECHNOLOGY LIMITED, Changzhou City, Jiangsu Province (CN)

(72) Inventor: hua ZHANG, Changzhou City , Jiangsu Province (CN)

(21) Appl. No.: 16/498,208

(22) PCT Filed: Jul. 8, 2019
(86) PCT No.: PCT/CN2019/095039

§ 371 Date: Sep. 26, 2019

(30) Foreign Application Priority Data
Jun. 28, 2019 (CN) 201920997463.8

(51) Int. Cl. H01M 10/6554; H01M 10/653; H01M 50/209; H01M 10/613; H01M 50/271

(52) U.S. Cl. CPC H01M 10/6554; H01M 10/653; H01M 50/271; H01M 10/613; H01M 50/209

(57) ABSTRACT

The present disclosure relates to the technical field of energy storage devices, and particularly, to a battery module. The battery module includes a lower case, a plurality of battery cells sequentially stacked and received in the lower case; and a heat conducting plate. A boss is formed on the lower case. The heat conducting plate is provided with a receiving hole. The boss fits in the receiving hole, and the boss is hot-melted and fixed in the receiving hole. In the present disclosure, through the fitting of the boss and the receiving hole and the subsequent hot-melting, the hot-melted boss forms a fixed connection with the receiving hole, which solves the spattering problem caused by welding in the related art and improves the connection strength between the lower case and the heat conducting plate.

### TECHNICAL FIELD

The present disclosure relates to the field of energy storage devices, and particularly, to a battery module.

### BACKGROUND

A battery module is generally used as an energy storage system of a new energy vehicle, and the existing battery module includes a metal lower case. The metal lower case may generate spatter when being welded with other components such as an upper cover, and thus can lead to functional failures of other components. In addition, the metal lower case has a great weight and a lot of parts thereof are required to be electrically insulated. Once the insulation function of some parts fails, the quality of the battery module may be problematic.

A heat conducting plate is usually provided to dissipate heat from the battery module. When the lower case is welded to the heat conducting plate, the above-mentioned spattering problem also exists. Therefore, it is urgent to find a solution how to form a stable connection between the lower case and the heat conducting plate.

### SUMMARY

The present disclosure provides a battery module, aiming to solve the problems in the related art and achieve a stable connection between the lower case and the heat conducing plate.

The present disclosure provides a battery module, including a lower case, a plurality of battery cells sequentially stacked and received in the lower case; and a heat conducting plate;

wherein a boss is formed on the lower case;

the heat conducting plate is provided with a receiving hole; and

the boss fits in the receiving hole, and a part or an entirety of the boss is fixed in the receiving hole.

In an embodiment, the lower case is made of an insulating material.

In an embodiment, the heat conducting plate is made of metal.

In an embodiment, the receiving hole is a circular hole;

the boss forms a connecting portion and a limiting portion; and

the connecting portion is located in the receiving hole, and the limiting portion limits the heat conducting plate.

In an embodiment, the receiving hole is a tapered hole; a surface of the boss facing away from the plurality of battery cells is flush with a surface of the heat conducting plate facing away from the plurality of battery cells.

In an embodiment, a plurality of receiving holes is provided, and the plurality of the receiving holes is arranged at an edge portion of the heat conducting plate along a length direction of the battery module; and/or the plurality of the receiving holes is arranged at the edge portion of the heat conducting plate along a width direction of the battery module.

In an embodiment, the lower case comprises two side plates and two end plates, and the two end plates are respectively fixedly connected to the two side plates; a plurality of bosses corresponding to the plurality of receiving holes is arranged at bottoms of the two side plates along the length direction of the battery module; and/or the plurality of bosses is arranged at the bottoms of the two end plates along the width direction of the battery module.

In an embodiment, each of the two side plates comprises a first plate and a second plate which are connected in an L shape;

the first plate extends along a height direction of the battery module;

the second plate extends along the width direction of the battery module; and

the plurality of bosses is disposed on the second plate.

In an embodiment, the lower case is provided therein with a heat conducting structural adhesive fixed at the lower case.

In an embodiment, the battery module further includes an upper cover, and the upper cover and the lower case define a receiving cavity for receiving the plurality of the battery cells.

The technical solutions provided by the present disclosure can achieve the following beneficial effects.

The battery module provided by the present disclosure includes a lower case, a plurality of battery cells sequentially stacked and received in the lower case; and a heat conducting plate. A boss is formed on the lower case. The heat conducting plate is provided with a receiving hole. The boss fits in the receiving hole, and the boss is hot-melted and fixed in the receiving hole. Through the fitting of the boss and the receiving hole and the subsequent hot-melting, the hot-melted boss forms a fixed connection with the receiving hole, which solves the spattering problem caused by welding in the related art and improves the connection strength between the lower case and the heat conducting plate.

It should be understood that the above general description and the following detailed description are merely illustrative and are not intended to limit the present disclosure.

### DESCRIPTION OF DRAWINGS

In order to more clearly illustrate the technical solutions of the present disclosure or in the related art, drawings used in the specific embodiments or the description of the related art will be briefly described below. The drawings introduced as below merely illustrate some embodiments of the present disclosure, and those skilled in the art can obtain other drawings based on these drawings without any creative efforts.

FIG. 1 is an exploded view of a battery module provided in an embodiment of the present disclosure;

FIG. 2 is a top view of a battery module provided in a first embodiment of the present disclosure;

FIG. 3 is a cross-sectional view taken along line A-A in FIG. 2;

FIG. 4 is an enlarged view of a portion B in FIG. 3;

FIG. 5 is a schematic exploded view showing a structure of the battery module provided in the first embodiment of the present disclosure, in which a lower case and a heat conducting plate are to be fitted with each other;

FIG. 6 is an enlarged view of a portion C in FIG. 5;

FIG. 7 is a top view of a battery module provided in a second embodiment of the present disclosure;

FIG. 8 is a cross-sectional view taken along line E-E in FIG. 7;

FIG. 9 is an enlarged view of a portion F in FIG. 8;

FIG. 10 is a schematic exploded view showing a structure of the battery module provided in the second embodiment of the present disclosure, in which the lower case and the heat conducting plate are to be fitted with each other; and

FIG. 11 is an enlarged view of a portion D in FIG. 10.

### REFERENCE SIGNS

1 battery module;

11 lower case;

111 boss;

111a connecting portion;

111b limiting portion;

112 side plate

112a first plate;

112b second plate;

113 end plate;

12 battery cell;

13 top cover;

14 structural adhesive;

15 heat conducting plate; and

151 receiving hole.

The drawings described herein, which illustrate the embodiments of the present disclosure, are incorporated in and constitute a part of the specification, and used to explain the principles of the present disclosure in combination with the specification.

### DESCRIPTION OF EMBODIMENTS

The technical solutions of the present disclosure will be clearly and thoroughly described as follow with reference to the accompanying drawings. It is obvious that the described embodiments are parts of the present disclosure, rather than all embodiments. Based on the embodiments of the present disclosure, all other embodiments obtained by those skilled in the art without paying any inventive efforts shall fall within the protection scope of the present disclosure.

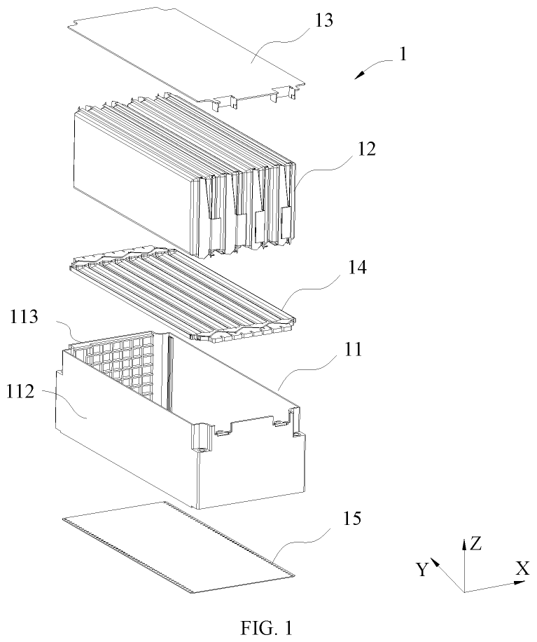

FIG. 1 is an exploded view of a battery module provided in a first embodiment of the present disclosure. As shown in FIG. 1, the embodiment of the present disclosure provides a battery module 1. The battery module 1 includes a lower case 11, a plurality of battery cells 12 sequentially stacked and received in the lower case 11, and an upper cover 13. The upper cover 13 and the lower case 11 together form a receiving cavity for receiving the plurality of battery cells 12.

An electrode assembly and electrolyte are disposed in the battery cell 12, and the electrode assembly electrochemically reacts with the electrolyte to output electric energy. Since heat generated during the reaction should be dissipated in time, the battery module 1 further includes a heat conducting plate 15 for heat dissipation.

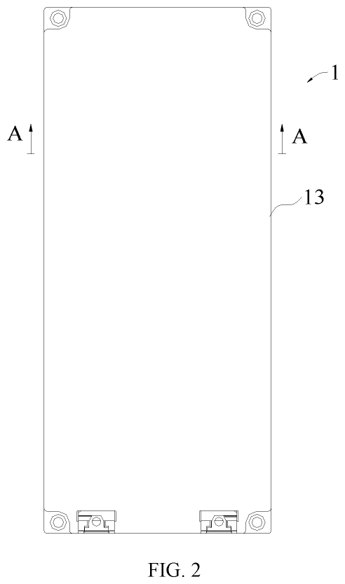

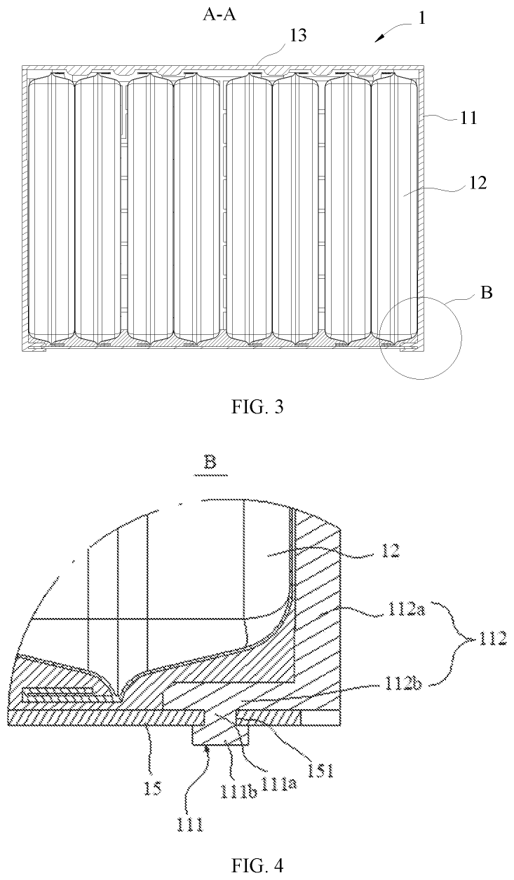

FIG. 2 is a top view of a battery module provided in a first embodiment of the present disclosure, FIG. 3 is a cross-sectional view taken along line A-A in FIG. 2, and FIG. 4 is an enlarged view of a portion B in FIG. 3.

A boss 111 is formed on the lower case 11, and the heat conducting plate 15 is provided with a receiving hole 151. The boss 111 fits in the receiving hole 151. A part or an entirety of the boss 111 is fixed in the receiving hole 151. Thus, the spattering problem caused by welding in the related art can be solved, and the connection strength between the lower case 11 and the heat conducting plate 15 can be increased. The battery module provided by the embodiment of the present disclosure is provided with the receiving hole 151 on the heat conducting plate 15 and a boss 111 is formed on the lower case 11, so that compared with the case in which the heat conducting plate 15 is injection-molded on the lower case 11 as a whole, the heat conducting plate 15 is only locally heated instead of being heated for the entire large area. Therefore, problems such as high temperature deterioration will not occur to the heat conducting plate 15, and a relatively large deformation, which will result in a decrease in flatness, will not occur. The reason for that is once the flatness of the heat conducting plate 15 is lowered, the contact effect between the battery module 1 and the outside will be affected, thereby affecting the heat dissipation of the battery module 1.

The lower case 11 and the heat conducting plate 15 adopt a split structure as described above, and thus the lower case 11 and the heat conducting plate 15 can be made of different materials. For example, the lower case 11 can be made of an insulating material, so as to solve the problem of metal spattering during the welding process of the metal lower case in the related art while reducing the weight of the battery module 1. The heat conducting plate 15 can be made of a material having a good thermal conductivity, such as using a metal heat conducting plate 15 to dissipate the heat of the battery cells 12, thereby improving the heat dissipation effect. In addition, the lower case 11 made of the insulating material can solve problems such as a lots of parts of the metal lower case are required to be insulated and insulations are often ineffective.

The boss 111 may be formed in the injection molding process of the lower case 11, and the receiving hole 151 can be formed on the heat conducting plate 15 by mechanical processing. Thus, the molding processes of the boss 111 and the receiving hole 151 are both very simple, and it is also easy to implement the hot-melting process of the boss 111 and the receiving hole 151.

In an embodiment, the battery module 1 may include two side plates 112 and two end plates 113. The side plates 112 and the end plates 113 fix the battery cells 12 to restrict the expansion of the battery cells 12. The heat conducting plate 15 can be connected to ends of the side plates 112 and the end plates 113 facing away from the upper cover 13, i.e., being connected to bottoms of the side plates 112 and/or the end plates 113. When the plurality of battery cells 12 is disposed in the lower case 11, the heat can be dissipated through the heat conducting plate 15.

The side plate 112 may include a first plate 111a, and the above boss 111 is disposed on the first plate 111a. It is also possible that as shown in FIG. 4, the side plate 112 includes a first plate 111a and a second plate 111b which are connected in an L shape. The first plate 111a extends in a height direction (Z direction in FIG. 1) of the battery module 1, and the second plate 111b extends in a width direction (X direction) of the battery module 1. The above boss 111 is provided on the second plate 111b. In an embodiment, the boss 111 and the side plate 112 can be formed into one piece by injection molding. In other embodiments, the boss 111 can also be disposed on the end plate 113 and formed into one piece with the end plate 113 by injection molding.

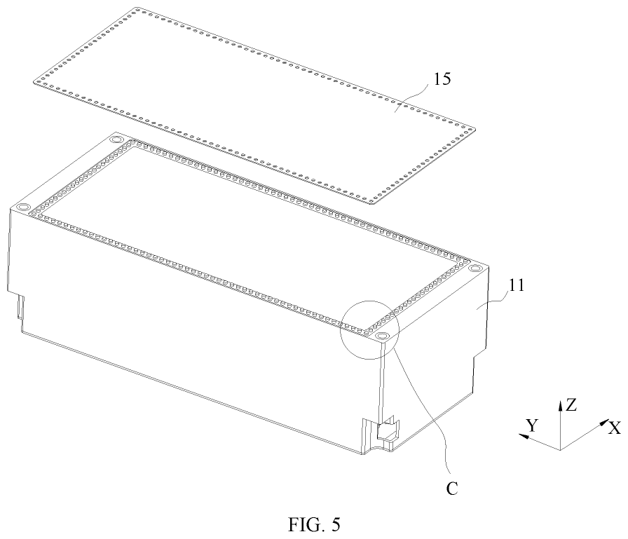

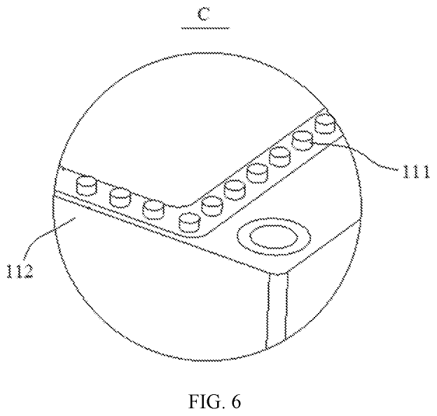

FIG. 5 is a schematic exploded view showing a structure of the battery module provided in the first embodiment of the present disclosure, in which the lower case and the heat conducting plate are to be fitted with each other, FIG. 6 is an enlarged view of a portion C in FIG. 5.

In the specific embodiment, the receiving hole 151 is a circular hole, and the boss 111 is cylindrical before hot-melting, as shown in FIG. 6. The hot-melted boss 111 forms a connecting portion 111a and a limiting portion 111b. Referring to FIG. 4, the connecting portion 111a is located in the receiving hole 151, and the limiting portion 111b limits the heat conducting plate 15.

The above structure can achieve a quick assembly of the heat conducting plate 15, and the limitation effect of the limiting portion 111b prevents the heat conducting plate 15 from escaping, thereby improving the reliability of the connection between the heat conducting plate 15 and the lower case 11.

The above receiving hole 151 and the boss 111 can have other shapes, as long as they can satisfy that the boss 111 is hot-melted after passing through the receiving hole 151.

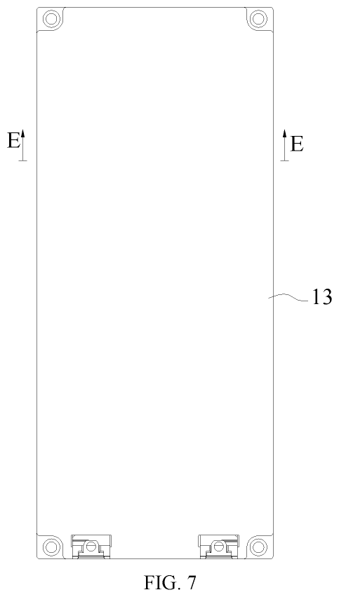

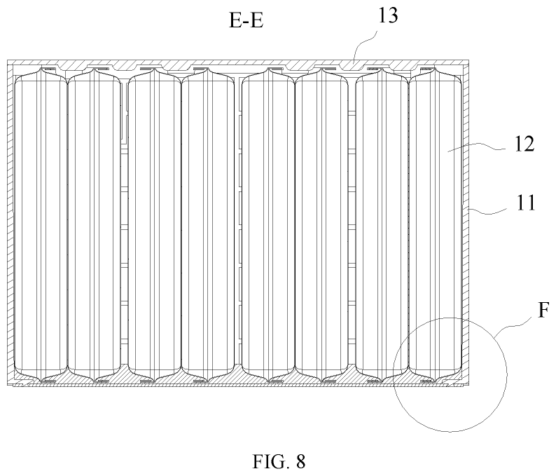

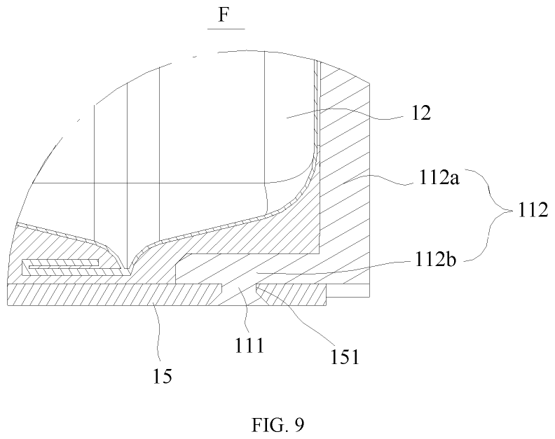

FIG. 7 is a top view of a battery module provided in a second embodiment of the present disclosure, FIG. 8 is a cross-sectional view taken along line E-E in FIG. 7, and FIG. 9 is an enlarged view of a portion F in FIG. 8.

In an implementation, as shown in FIG. 7 to FIG. 9, the receiving hole 151 is a tapered hole, i.e., an aperture of the receiving hole 151 on a side facing away from the battery cell 12 is larger than its aperture on a side close to the battery cell 12. The boss 111 has a cylindrical shape before hot-melting, and a surface of the hot-melted boss 111 facing away from the battery cell 12 is flush with a surface of the heat conducting plate 15 facing away from the battery cell 12.

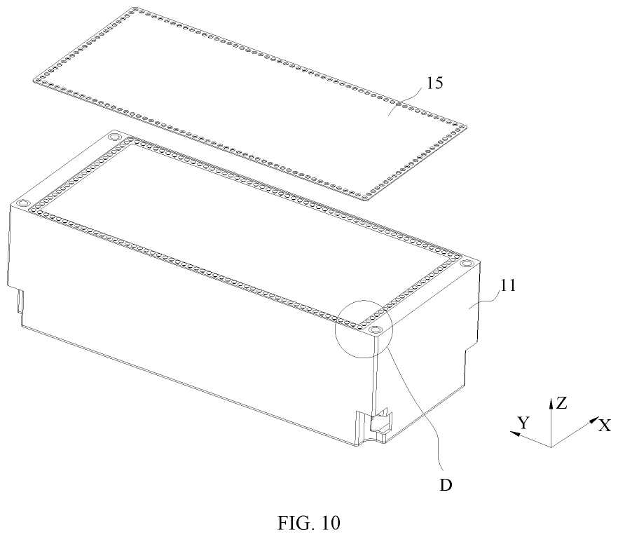

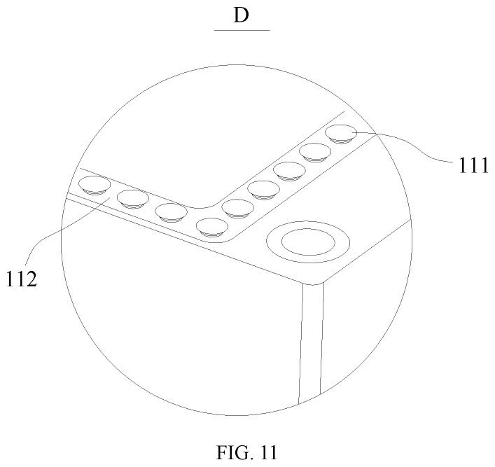

FIG. 10 is a schematic exploded view showing a structure of the battery module provided in the second embodiment of the present disclosure, in which the lower case and the heat conducting plate are to be fitted with each other; and FIG. 11 is an enlarged view of a portion D in FIG. 10.

Referring to FIGS. 9 and 11, FIG. 11 shows a state of the hot-melted boss 111. At this time, the boss 111 is completely filled in the receiving hole 151 to form a shape similar to a “nail cap”. A surface of the hot-melted boss 111 facing away from the battery cell 12 is flush with a surface of the heat conducting plate 15 facing away from the battery cell 12, such that the occupied space of the battery module 1 is reduced and the space utilization rate is high, thereby enhancing the energy density of the battery module 1.

As described above, the lower case 11 can be made of a polymer material having an insulating property, and is formed by a molding method such as injection molding, extrusion or mold pressing. In this way, the spattering during welding of the metal lower case in the related art and the failures of other components can be avoided, and thus the quality of the battery module 1 is improved.

The battery cell 12 can have a square or cylindrical shape, which is not limited herein.

The upper cover 13 can be made of a polymer material having an insulating property, and is formed by molding method such as injection molding, extrusion or mold pressing.

The heat conducting plate 15 is made of metal, which has a higher thermal conductivity than the lower case 11 and the upper cover 13. For example, the heat conducting plate is made of metal such as copper or aluminum, which is not further limited herein.

Further, the heat conducting plate 15 is a rectangular plate. It can be understood that the heat conducting plate 15 can also have other shapes as long as it matches with the shape of the lower case 11.

Further, a plurality of receiving holes 151 can be provided. The plurality of receiving holes 151 are arranged at an edge portion of the heat conducting plate 15 along the length direction (direction Y) of the battery module 1. The receiving holes 151 can also be arranged at the edge portion of the heat conducting plate 15 along the width direction (X direction) of the battery module 1. The receiving holes 151 can also be arranged at the edge portion of the heat conducting plate 15 along both the width direction (X direction) and the length direction (Y direction) of the battery module 1. In the embodiment, as an example, the receiving holes 151 are arranged at the edge portion of the heat conducting plate 15 along the length direction and the width direction of the battery module 1, such that more receiving holes 151 can be provided to fit with the bosses 111 on the lower case 11. In view of this, there are more connecting points and the connection strength is greater, and thus the overall structural strength of the battery module 1 is improved.

Correspondingly, positions of the bosses 111 correspond to those of the receiving holes 151, and can be arranged at the bottom of the side plate 112 along the length direction (Y direction) of the battery module 1, and can also be arranged at the bottom of the end plate 113 along the width direction (X direction) of the battery module 1. The boss 111 can also be provided at bottoms of both the side plate 112 and the end plate 113 both along the length direction (Y direction) of the battery module 1 and along the width direction (X direction) of the battery module 1.

In an embodiment, the lower case 11 is provided therein with a structural adhesive 14 fixed to the lower case 11, and the structural adhesive 14 can be a heat conducting structural adhesive. During the assembling of the battery module 1, the lower case 11, the battery cells 12 and the upper cover 13 are assembled first, and then the adhesive is applied. Thus, the application of the adhesive can be monitored in real time, so as to ensure a good application effect of the adhesive. After the adhesive is applied, the receiving hole 151 of the heat conducting plate 15 is fitted and hot-melted with the boss 111 of the lower case 11 to form a stable connection between the heat conducting plate 15 and the lower case 11. The process sequence of assembling the heat conducting plate 15 after applying the adhesive can also prevent the adhesive from overflowing from the lower case 11, and the heat conducting structural adhesive is conducive to the heat transfer, thereby further improving the heat dissipation effect of the battery module 1.

The preferable embodiments of the present disclosure described above are not intended to limit the claims. Those skilled in the art can make various modifications and changes. Any modification, equivalent substitution and improvement made without departing from the concept of the present disclosure shall fall within the protection scope of the present disclosure.

What is claimed is:

1. A battery module, comprising:
a lower case;
a plurality of battery cells sequentially stacked and received in the lower case; and
a heat conducting plate,
wherein a boss is formed on the lower case;
the heat conducting plate is provided with a receiving hole; and
the boss fits in the receiving hole, and a part or an entirety of the boss is fixed in the receiving hole.

2. The battery module according to claim 1, wherein the lower case is made of an insulating material.

3. The battery module according to claim 1, wherein the heat conducting plate is made of metal.

4. The battery module according to claim 1, wherein the receiving hole is a circular hole, and the boss forms a connecting portion and a limiting portion;
the connecting portion is located in the receiving hole, and the limiting portion limits the heat conducting plate.

5. The battery module according to claim 1, wherein the receiving hole is a tapered hole; a surface of the boss facing away from the plurality of battery cells is flush with a surface of the heat conducting plate facing away from the plurality of battery cells.

6. The battery module according to claim 1, wherein a plurality of receiving holes is provided, and the plurality of the receiving holes is arranged at an edge portion of the heat conducting plate along a length direction of the battery module; and/or the plurality of the receiving holes is arranged at the edge portion of the heat conducting plate along a width direction of the battery module.

7. The battery module according to claim 6, wherein the lower case comprises two side plates and two end plates, and the two end plates are respectively fixedly connected to the two side plates; a plurality of bosses corresponding to the plurality of receiving holes is arranged at bottoms of the two side plates along the length direction of the battery module; and/or the plurality of bosses is arranged at the bottoms of the two end plates along the width direction of the battery module.

8. The battery module according to claim 7, wherein each of the two side plates comprises a first plate and a second plate which are connected in an L shape;
the first plate extends along a height direction of the battery module;
the second plate extends along the width direction of the battery module; and
the plurality of bosses is disposed on the second plate.

9. The battery module according to claim 1, wherein the lower case is provided therein with a heat conducting structural adhesive fixed at the lower case.

10. The battery module according to claim 1, further comprising an upper cover,
wherein the upper cover and the lower case define a receiving cavity for receiving the plurality of the battery cells.
